(19) United States
(12) Patent Application Publication
(10) Pub. No.: US 2016/0208998 A1
(43) Pub. Date: Jul. 21, 2016

(54) TUNABLE LUMINAIRE AND RELATED METHODS TO CONTROL LIGHT OUTPUT

(71) Applicant: DELTA T CORPORATION, Lexington, KY (US)

(72) Inventor: Tom GREINKE, Lexington, KY (US)

(73) Assignee: DELTA T CORPORATION, Lexington, KY (US)

(21) Appl. No.: 14/915,036

(22) PCT Filed: Aug. 26, 2014
(86) PCT No.: PCT/US14/52646

§ 371 Date: Feb. 26, 2016

Related U.S. Application Data
(60) Provisional application No. 61/869,989, filed on Aug. 26, 2013.

(51) Int. Cl. F21V 5/04; G06Q 10/00; G06Q 20/20; F21V 15/01; F21V 23/02

(52) U.S. Cl. CPC F21V 5/04; F21V 15/013; F21V 23/02; G06Q 20/20; G06Q 10/20; F21Y 2101/02; F21Y 2103/00

(57) ABSTRACT

A light fixture may include one or more light sources and one or more lenses for manipulating light provided by the light sources. The lenses may manipulate the direction of the light, light wavelength, dispersion pattern, or any other quality of the light. The lenses may be slidably removable from the light fixture to provide for easy exchange of one lens for another. This exchange of one lens for another may provide for rapid and easy changes to the light dispersion from the light fixture without requiring manipulation of the light sources themselves, especially in the case of exchanging a first lens with a first quality for a second lens with a second, different quality. In addition, a method of servicing the light fixture may include the provision of alternate lenses based on predetermined factors such as time, light degradation, environment of use, and the occurrence of specified events.

This application claims priority to U.S. Provisional Patent Application No. 61/869,989, filed Aug. 26, 2013, the disclosure of which is incorporated herein by reference.

### TECHNICAL FIELD

This application relates to the lighting arts and, in particular, a tunable luminaire.

### BACKGROUND

Luminaires or lighting fixtures are used for providing artificial light where needed, such as in buildings or outdoor areas. A typical arrangement includes a plurality of light sources carried in a single, elongated fixture and arranged in tandem for lighting a particularly wide area, such as an open floor space in a warehouse or an office space. While this type of lighting works for its intended purpose, a degree of efficiency may be lost due to the inability to control the general direction of the light emanating from the fixture. This lack of control of the light output may be disadvantageous in some situations, such as when the lighting fixture is used closely adjacent to a wall, and the desire may be to project the light away from, rather than onto, the wall itself. Likewise, there may be a desire to illuminate a particular location, such as a piece of equipment, with focused light, while also illuminating an adjacent floor space in a wider manner.

Luminaires are often used in conditions where there is a significant amount of airborne dust and dirt, such as manufacturing or industrial facilities. The collection of the dust and dirt on the luminaire may cause performance to suffer. However, cleaning the luminaire is time consuming, and the parts that output the light, such as lenses, are ordinarily not removable. Hence, it is also common for luminaires to be sold for use, and then either ignored (with a corresponding degradation in performance) or treated as disposable items (i.e., discarded when “spent,” such as when the light output degrades to a low level).

Accordingly, a need is identified for an improved luminaire that provides the ability to tune the light output for greater efficiency of operation, especially in enclosed spaces such as warehouses, factories, or other industrial establishments. The luminaire would be simple in construction, and could be adjusted in a variety of manners in order to achieve the desired objectives of tuned lighting. Related improvements are also proposed.

### SUMMARY OF THE INVENTION

The invention relates to a tunable luminaire. The luminaire may include a fixture having a longitudinal direction and including at least one first light source and at least one second light source spaced from the first light source in a lateral direction. A first lens may be provided which is removably connected to the fixture independently of the first light source, said first lens for receiving light projected from the first light source. In addition, a second lens may be provided which is removably connected to the fixture independently of the second light source and generally parallel to the first lens, said second lens for receiving light projected from the second light source. The first lens and the second lens may produce different light outputs.

In one aspect, the first and second lenses may be spaced apart from each other on opposite sides of the fixture or on the same side of the fixture. At least the first lens may be slidably received in the fixture. The first Tense may create a first output angle for the light emanating from the first light source, which is different from a second output angle created by the second lens for the light emanating from the second light source.

The lenses may be interchangeable within the fixture. One or each of the first and second lenses may include a handle.

The light source may comprise at least one LED. In one embodiment, the light source includes a plurality of LEDs.

In another aspect, a first compartment in the fixture may include the first light source and a second compartment in the fixture may include the second light source. Each of the first and second lenses may be removably attached to the fixture for substantially covering the first and second compartments, respectively.

The first lens may generate a first light output having a first beam angle and the second lens may generate a second light output having a second beam angle different from the first beam angle. In another aspect, the first lens may generate a first light output having a first pattern and the second lens may generate a second light output having a second pattern different from the first pattern. In a further aspect, the first lens may generate a first light output having a first wavelength and the second lens may generate a second light output having a second wavelength different from the first wavelength. Still further, the first lens may generate a first light output having a narrow width and the second lens may generate a second light output having a width wider than the narrow width. The luminaire may comprise a single piece extrusion for supporting the lenses.

In a further aspect, the luminaire may include a power source for powering the first or second light sources. The power source may by mounted in contact with the single piece extrusion.

The fixture may comprise a first compartment including the first light source and a second compartment including the second light source. The first lens may cover the first compartment and the second lens may cover the second compartment. The first light source may include a single light or a plurality of lights. Similarly, the second light source may include a single light or a plurality of lights. The first compartment and the second compartment may be spaced from each other in the longitudinal or the lateral direction.

In another embodiment, an apparatus for lighting a space is disclosed. The apparatus may include a first luminaire including a first light source associated with a first lens and a second luminaire including a second light source associated with a second lens. The first and second lenses may produce different outputs and may be interchangeable between the first and second luminaires. The first luminaire may include a third lens interchangeable with the first lens or the second lens. The first and second lenses may be elongated in a longitudinal direction.

In a further embodiment, a luminaire is disclosed which may include at least one slidably removable lens for regulating light emanating from a plurality of light sources.

Another embodiment relates to a luminaire including at least four slidably removable lenses for regulating light emanating from a plurality of light sources.

A further embodiment discloses a luminaire comprising a fixture including a single piece extrusion in contact with a power source for powering at least one light source.

An additional embodiment relates to a luminaire comprising a fixture including a single piece extrusion in contact with a plurality of power sources for powering one or more light sources.

The invention also relates to a method of providing service for the luminaire as disclosed herein which may have been purchased by a purchaser. The method comprises providing to the purchaser one or more first replacement lenses for one or more original lenses of the luminaire based on a pre-determined event. In one aspect, the predetermined event may be selected from the group consisting of the passage of a specific amount of time, a determination that the existing light output lens is at or below a specified original or estimated original light output, or a combination thereof. In another aspect, the predetermined event may be selected based on one or more of a type of facility in which the luminaire is located and the type of industry occurring at a facility in which the luminaire is located.

The method may further include the steps of removing the lens and replacing it with the first replacement lens, and providing one or more second replacement lenses for the one or more first replacement lenses of the luminaire based on a pre-determined event.

In a further aspect, the method may include the further step of replacing a first lens of the luminaire with a first replacement lens, and replacing the second lens of the luminaire with a second replacement lens, wherein the first replacement lens and the second replacement lens produce different light outputs.

In a further embodiment, a method is disclosed for providing different light outputs from a single luminaire having a plurality of light sources. The method may include providing a first lens in the single luminaire for producing a first light output from one of the light sources, and providing a second lens in the single luminaire for producing a second light output from another of the light sources. The first lens may be exchanged with either the second lens or a third lens different from the second lens, said third lens having a third light output different from the first or second light output.

A still further embodiment relates to a method of providing service for a luminaire comprising providing service for a luminaire based on the occurrence of a pre-determined event. The predetermined event may be selected from the group consisting of the passage of a specific amount of time, a determination that the existing light output lens is at or below a specified percentage of an original or estimated original light output, or a combination thereof. In another aspect, the predetermined event may be selected based on one or more of a type of facility in which the luminaire is located and the type of industry occurring at a facility in which the luminaire is located.

The method may further include the step of removing the original lens and replacing it with the first replacement lens. In addition, one or more second replacement lenses may be provided for the one or more first replacement lenses of the luminaire based on a pre-determined event. The method may include the step of replacing a first lens of the luminaire with a first replacement lens, and replacing the second lens of the luminaire with a second replacement lens, wherein the first replacement lens and the second replacement lens produce different light outputs.

The providing step may be performed by a seller of the luminaire in connection with an original sale of the luminaire by a purchaser. In one aspect, the providing step is provided by other than a seller of the luminaire to a purchaser.

In a further embodiment of the present invention, a method is disclosed for regulating a light output from a luminaire including at least one removable lens. The method may include, after a period of time following an installation of the luminaire, checking the light output. At least one lens may be replaced if the light output is below a predetermined level. The replacing step may be performed based on a service contract between a seller of the luminaire and a purchaser of the luminaire.

Another embodiment of the present invention includes a method of regulating a light output from a luminaire including at least one removable lens purchased by a purchaser directly or indirectly from a seller. After a period of time following an installation of the luminaire by or for the purchaser, the seller may replace the at least one lens with a replacement lens. The replacing step may be performed based on a service contract between the seller of the luminaire and the purchaser of the luminaire.

The above methods may further include the step of providing the service contract specifying a time interval for replacing the at least one lens with a replacement based on an amount of light output during or at the end of the time interval. In addition, the method may include the step of specifying the time interval and the amount of light output based on a characteristic of the purchaser.

An additional embodiment relates to the selling of a luminaire. This method includes, at a point of sale, providing a service obligation respecting maintenance of the luminaire. In addition, service of the luminaire may be provided based on an amount of light output. The providing of service of the luminaire may be provided based on an amount of light output after a particular amount of time passes. The providing of service may be based on an amount of light output after a particular amount of time and for a particular commercial or industrial use of the luminaire.

A final embodiment discloses a method of selling a luminaire comprising providing a service obligation respecting replacing one or more lenses of the luminaire. The provision of these service obligation may be based on a light output by the luminaire. The method may further include the step of delivering the one or more lenses to a location of the luminaire.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a top perspective view of a luminaire;

FIG. 2 is a bottom perspective view of the luminaire;

FIG. 3 is a bottom view of the luminaire including lenses;

FIG. 4 is an end view of the luminaire including lens handles;

FIG. 5 is a cross-section of a compartment of the luminaire including the light source and lens;

FIG. 6 is a top perspective view of the luminaire illustrating the removal of the lenses;

FIGS. 7-9 are end views of luminaires including various lenses for directing light;

FIG. 10 illustrates two luminaires including lenses for attenuating light and for dispersing light along a plurality of directions;

FIG. 11 is a cross-section of the extrusion including a door; and

FIG. 12 is a bottom perspective view of the luminaire with the door open.

### DETAILED DESCRIPTION

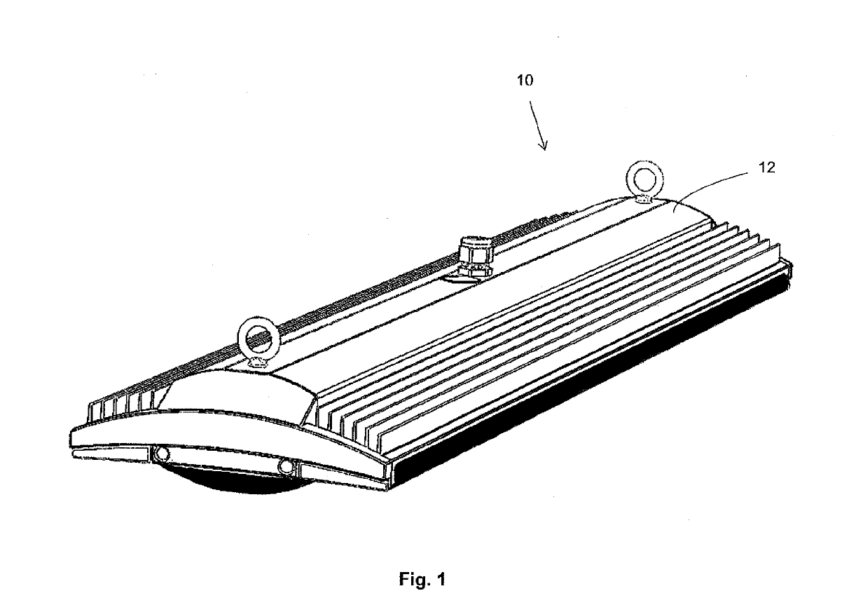

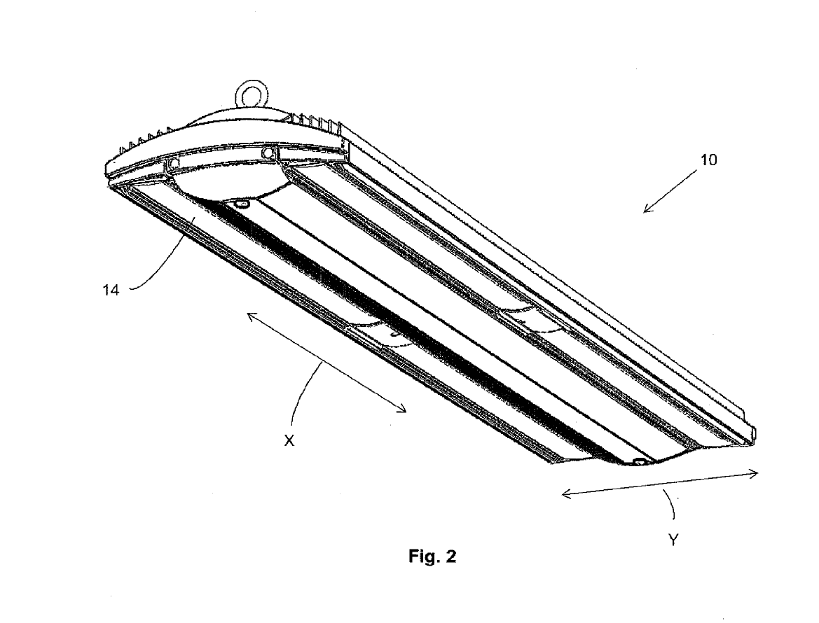

Reference is now made to FIGS. 1-3, which illustrate one embodiment of a luminaire 10. The luminaire 10 includes a fixture 12 for housing a plurality of light sources, such as light-emitting diodes, or LEDs. In the illustrated embodiment, the light sources comprise four separate arrangements of one or more LEDs, arranged in tandem on each side of the lighting fixture 10 (e.g., each source spaced from another in the longitudinal direction X, as well as in the transverse direction Y). However, the disclosure is not limited to any particular arrangement or type of lights or light sources, and may have applicability in other arrangements, without limitation.

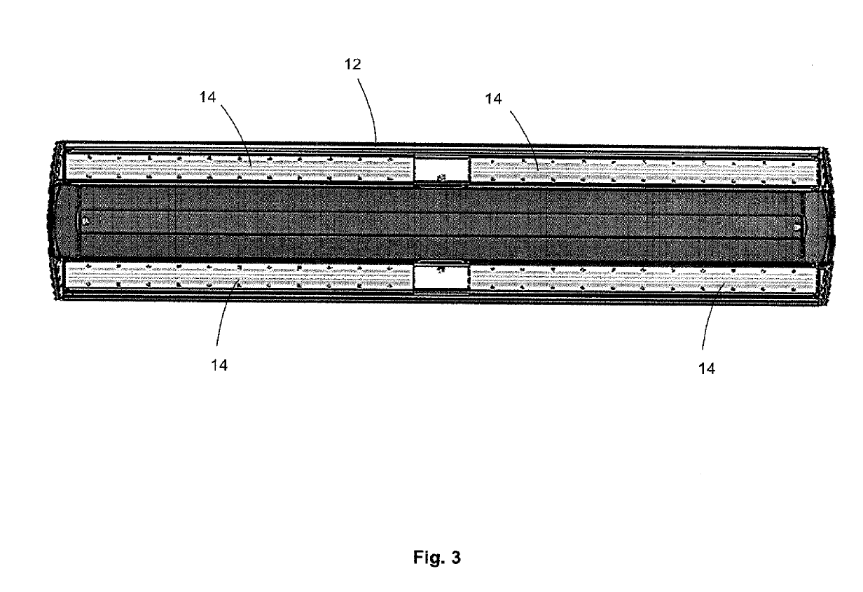

As perhaps best understood with reference to FIGS. 3, 4, and 5, the light sources L may be positioned in individual compartments associated with at least partially translucent portions, which are termed lenses 14 for purposes of this disclosure, but may also be referred to as trays. In the illustrated embodiment, the lenses 14 each comprise elongated pieces of a relatively lightweight material, such as plastic (e.g., acrylic), that are arranged to substantially cover and contain the light sources L in the respective compartments. However, the lenses 14 could also be made of glass as well, or glass or plastic may be provided in combination with different materials (e.g., metal, composites, etc.). As suggested above, the lenses 14 need not be entirely translucent, and may comprise combinations of translucent, transparent, or opaque materials. However, in one embodiment, each lens 14 comprises a single piece of material for producing the desired optical output from each light source associated with it (which may comprise multiple LEDs).

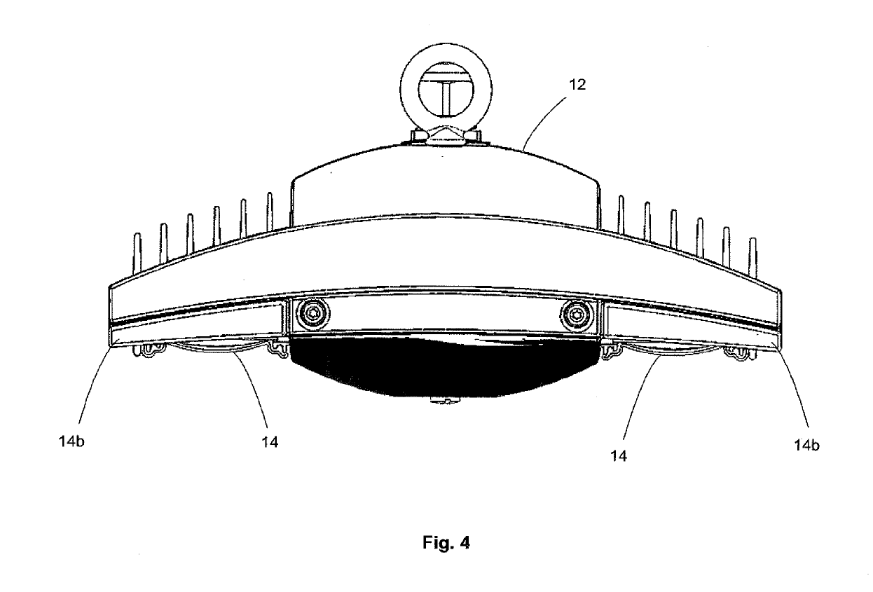

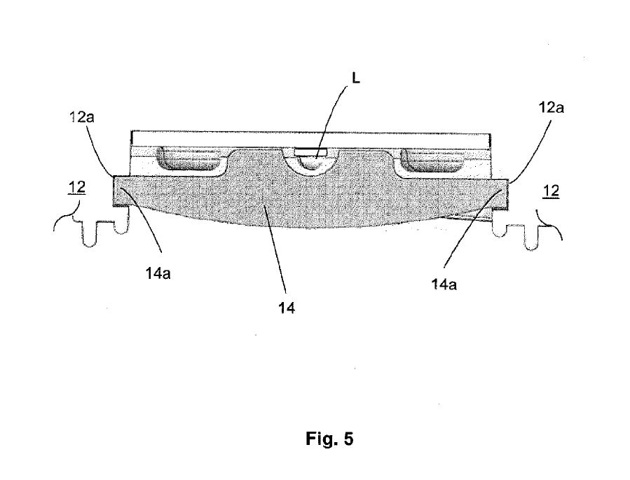

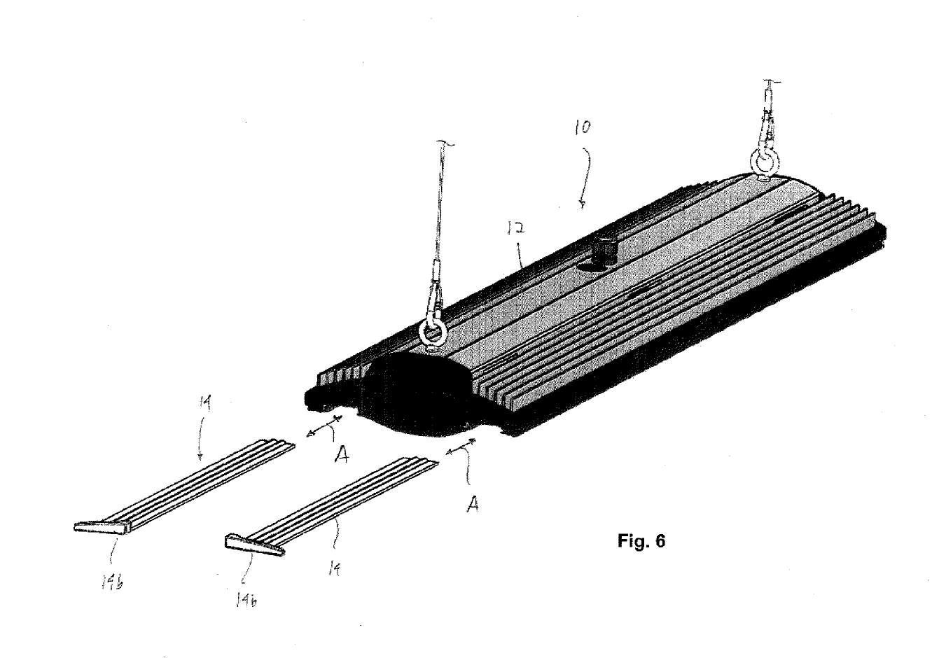

Each lens 14 may be independently mounted to the fixture 12, and thus may be individually removable. For example, as shown in FIGS. 4 and 5, each lens 14 may be received in a corresponding receiver, such as a channel, associated with the fixture 12. Specifically, each lens 14 may include a lateral edge portion 14a forming a tongue adapted for being received in a groove 12a formed in the fixture 12 that serves as part of the channel. Consequently, the lens 14 may be slidably removed and re-inserted in the longitudinal direction (see action arrow A in FIG. 6).

To facilitate manual grasping and manipulation, a handle 14b may be provided on each lens 14. This handle 14b may be detachable from the lens 14 to allow for it to be positioned on different lenses (or may be permanently attached to the lens and form an integral part of it). However, other means of associating the lenses with the fixture 12 may be utilized, as long as the replacement or exchange can be done in an efficient and effective manner (e.g., without the use of tools or fasteners).

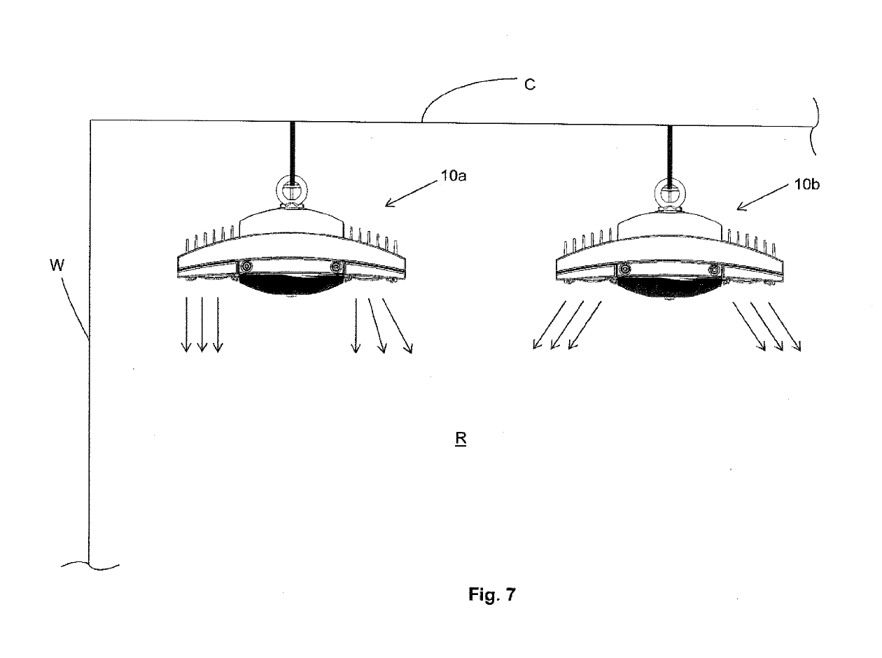

As should be appreciated, this capacity for easy exchange allows for different lenses 14 to be associated with the luminaire 10 (or different luminaires in the case where the lenses are substantially identical in size), depending on the intended use. For example, with reference to FIG. 7, a first luminaire 10a suspended from a ceiling C and positioned adjacent to a wall W may be provided with a corresponding lens on one side designed to focus the light primarily downwardly in a relatively narrow fashion, while a second lens associated with the same first luminaire 10a projects the light away from the wall W and into the room R in a wider manner. A second luminaire 10b in the same space may be provided with lenses that broadcast the light widely in order to help ensure that full coverage of the underlying space is provided in an efficient manner.

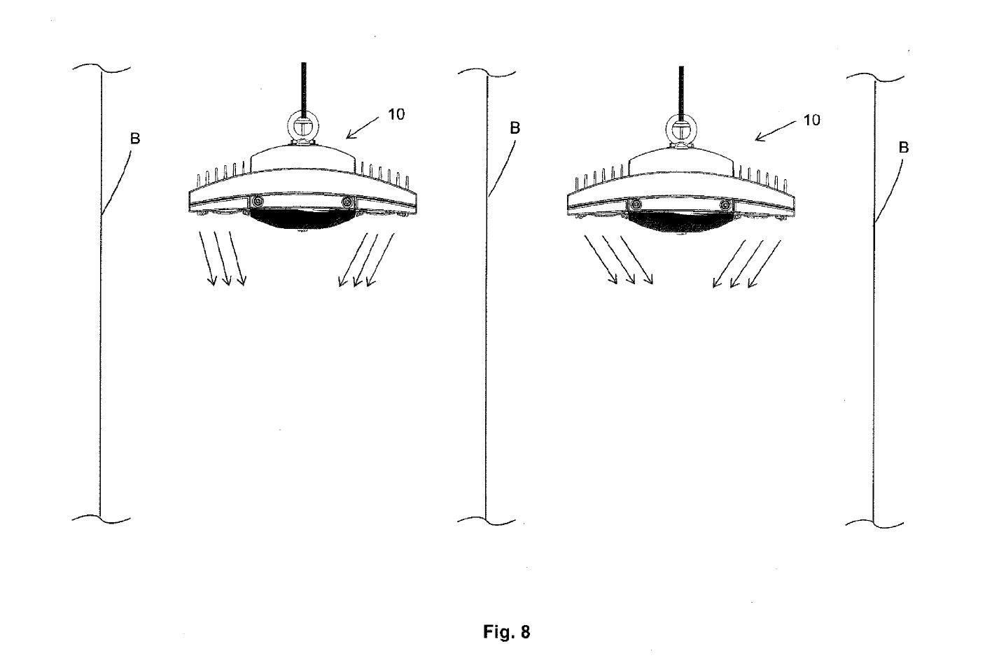

FIG. 8 illustrates that that luminaire 10 may be adapted to direct light inwardly, such as when positioned between structures, such as shelving units in a warehouse or the like (illustrated schematically by boundaries B). Of course, if the units are moved or rearranged such that the boundaries are altered, the lenses may be adjusted accordingly to change the light pattern (such as by swapping the lenses from different luminaires, or otherwise making the desired substitution to achieve the adjustment).

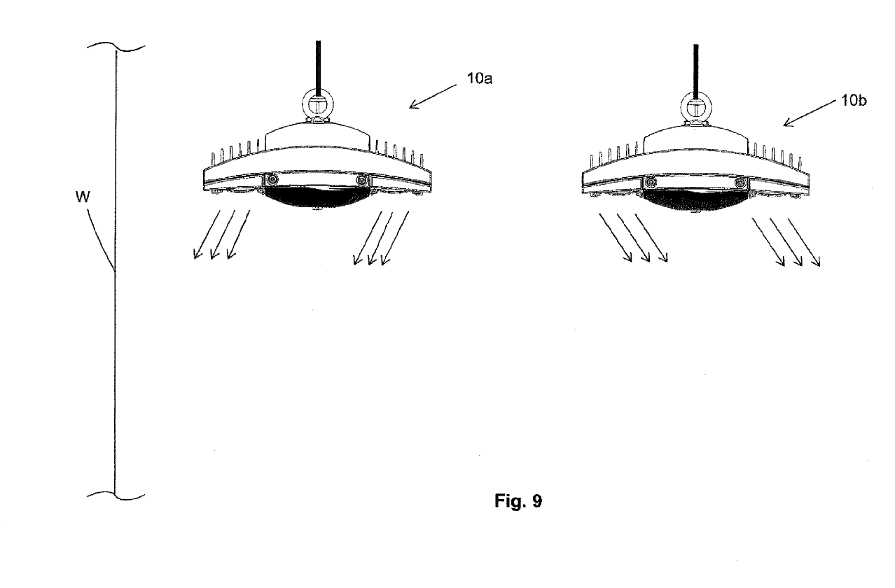

In another example, and with reference to FIG. 9, it may be desirable to project light from a first luminaire 10a onto an adjacent object, such as a wall W, while directing light from another luminaire 10b away from the object. As should be appreciated, this may be achieved by adjusting the lenses accordingly. Likewise, the lenses may be swapped among the luminaires 10a, 10b to change the arrangement in any desired manner.

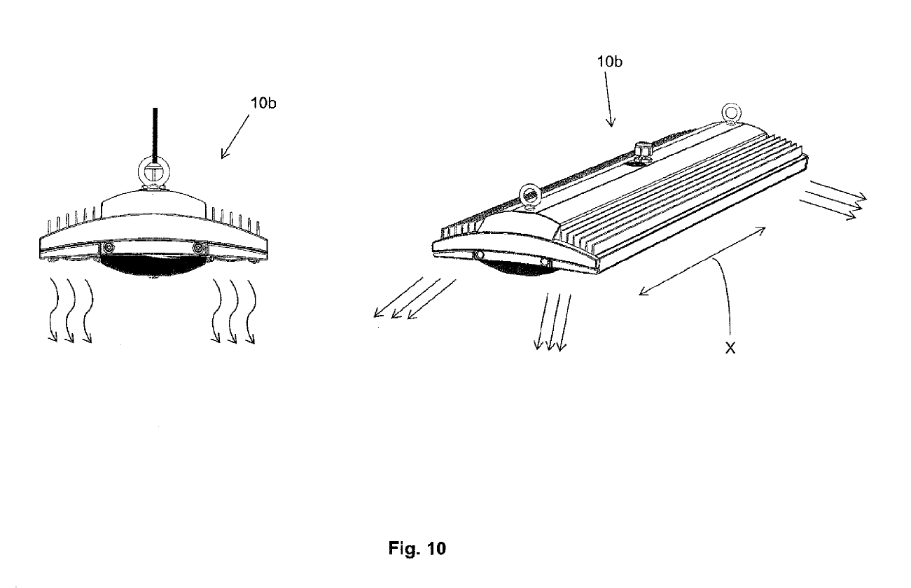

FIG. 10 illustrates further examples of features that may be achieved according to the concepts disclosed. For example, light may be attenuated in one luminaire 10a by the selected lens or lenses, such as for use in connection with a particular piece of equipment having a particularly light sensitive characteristic (e.g., UV curable materials or the like). The degree of attenuation may be adjusted by simply changing or exchanging the lenses so as to produce light output having the desired wavelengths (which may be groups of wavelengths or one or more individual wavelengths). This figure also illustrates that the lenses of another luminaire 10b may be used to adjust the light in the longitudinal direction X as well, as well as that the lighting fixtures may be oriented differently (and the lighting patterns created adjusting accordingly).

The lenses 14 may comprise any type of lenses desired for a particular light output from the luminaire 10. For example, the lenses 14 may comprise Fresnel lenses, spherical lenses, concave lenses (including bi-concave or plano-concave), convex lenses, lenses with a positive or negative meniscus, or any combinations of the foregoing. The particular selection and arrangement will depend on the desired application.

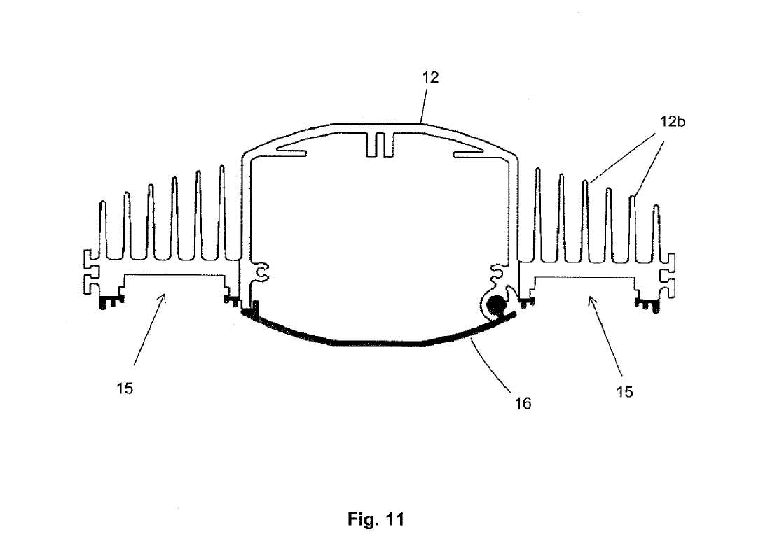

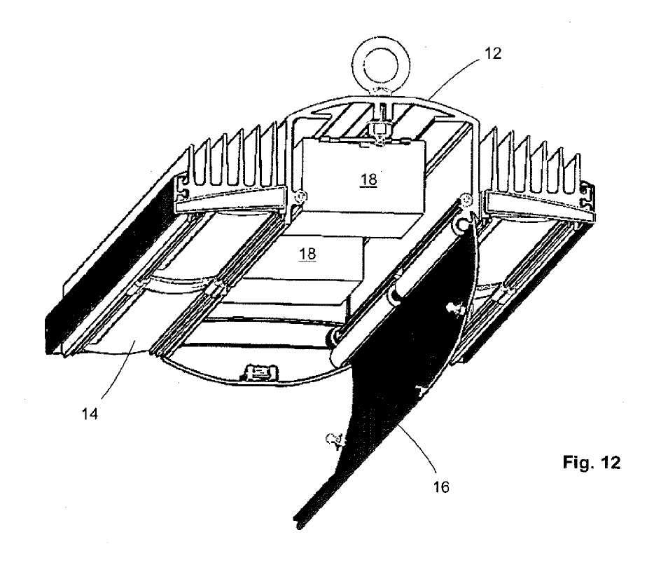

FIGS. 11-12 show that the fixture 12 may include a single metal extrusion, which may include heat dissipation structures, such as fins 12b. The extrusion may include one or more compartments or chambers 15 for housing the light source or light sources. The extrusion itself may also be adapted for receiving the lenses, as shown in FIG. 5. In one embodiment, a single lens 14 may be adapted to receive light from all light sources within a given chamber. The luminaire may include a plurality of pairs of lenses and chambers, wherein each lens is adapted to receive light from all light sources within a corresponding chamber. Stated another way, each chamber may be adapted to house a plurality of light sources and for distributing the light from the plurality of light sources through a single lens.

A door 16 may also be provided for providing access to components within the fixture 12, such as one or more power supplies 18 (FIG. 12), which may be in the form of inverters. The power supply or supplies 18 may be mounted directly in contact with the extrusion, such as in an interior chamber, in order to help dissipate any excess heat generated as the result of powering the light or lights in the luminaire 10.

It should also be appreciated that the lenses 14 may comprise a material that may degrade or accumulate dust and dirt over time, especially when used in industrial environments. While cleaning may be an option (and is facilitated by the easy removal procedure in the illustrated embodiment), this arrangement also allows for the easy and efficient replacement of the lenses, thus potentially extending the service life of the luminaire 10.

Along these lines, a further aspect of the disclosure relates to methods for ensuring that the light output from the luminaire 10 remains optimized. Specifically, a user of the luminaire 10 would contract with an outside service provider to provide periodic checks and possible replacement of the lenses 14 in order to ensure proper performance. As an example, the service provider may offer different levels or service based on a selected use of the luminaire (e.g., in a particular type of manufacturing facility), the amount of time in service, or both. The service provider (which may be the seller or a third party) may also contract with the purchaser of the luminaire (directly from the seller or from a third party) to provide a particular amount of light output during or at the end of a specified period based on an initial amount, such as 100%. When the light output is deemed to necessitate a positive adjustment (e.g., the level falls below the predetermined level, or after a particular amount of time passes), the service provider may service the lens or lenses 14 of each luminaire (either by replacement or cleaning), thus restoring the light output to an acceptable amount. Of course, any replacement of the corresponding light source(s) may also be done at that time, but in the case of LED based luminaires, the light source will long outlast several iterations of the service period in most cases. In any event, it can be appreciated that the service life of the luminaire may be greatly increased by caring for it in the proposed manner.

An example of one possible arrangement for providing service to a purchaser of a luminaire is provided in the following table:

| | Dirt Depreciation | Recommended | Lumens |
|---|---|---|---|
| Facility Type | (By Process) | Service Interval | (% of initial output) |
| Manufacturing | Light | 4 years | 95% |
| | Moderate | 3 years | 94% |
| | Heavy | 2 years | 93% |
| Distribution | Light | 5 years | 95% |
| | Moderate | 4 years | 93% |
| | Heavy | 3 years | 92% |
| Aviation | Light | 5 years | 95% |

The service obligation provided to a customer by the provider may thus specify, for example, that upon falling below a particular percentage of the original light output after or within a specified period of time, a replacement lens will be provided (such as by delivery, with installation by the seller, the purchaser, or a third party). In this manner, the optimal light output may be provided, and potentially without any significant disruption in the use of the luminaire.

The service contract between the purchaser of the luminaire 10 and the seller relating to the replacement of the lenses may be provided at the time of purchase of the luminaire, termed the point of sale. Alternatively, it may be provided later in time, such as part of a maintenance contract, either by the seller of the luminaire, the manufacturer of the luminaire, or a third party service provider.

The detection of the light output may be estimated for purposes of the service obligation. Alternatively, the actual light output may be measured using any known means, such as for example, a conventional light meter, or a sensor positioned on or adjacent to the luminaire.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the invention in various embodiments and with various modifications as are suited to the particular use contemplated.

1. A tunable luminaire, comprising:
a fixture having a longitudinal direction and including at least one first light source and at least one second light source spaced from the first light source in a lateral direction;
a first lens removably connected to the fixture independently of the first light source, said first lens for receiving light projected from the first light source; and
a second lens removably connected to the fixture independently of the second light source and generally parallel to the first lens, said second lens for receiving light projected from the second light source;
wherein the first lens and the second lens produce different light outputs.

2. The luminaire of claim 1, wherein the first and second lenses are spaced apart from each other on opposite sides of the fixture or on the same side of the fixture.

3. The luminaire of any of the foregoing claims, wherein at least the first lens is slidably received in the fixture.

4. The luminaire of any of the foregoing claims, wherein the first lens creates a first output angle for the light emanating from the first light source, which is different from a second output angle created by the second lens for the light emanating from the second light source.

5. The luminaire of any of the foregoing claims, wherein the lenses are interchangeable within the fixture.

6. The luminaire of any of the foregoing claims, wherein each of the first and second lenses includes a handle.

7. The luminaire of any of the foregoing claims, wherein the first light source comprises at least one LED.

8. The luminaire of claim 7, wherein the first light source comprises a plurality of LEDs.

9. The luminaire of any of the foregoing claims, wherein a first compartment in the fixture includes the first light source and a second compartment in the fixture includes the second light source, and each of the first and second lenses is removably attached to the fixture for substantially covering the first and second compartments, respectively.

10. The luminaire of any of claims 1-9, wherein the first lens generates a first light output having a first beam angle and the second lens generates a second light output having a second beam angle different from the first beam angle.

11. The luminaire of any of claims 1-9, wherein the first lens generates a first light output having a first pattern and the second lens generates a second light output having a second pattern different from the first pattern.

12. The luminaire of any of claims 1-9, wherein the first lens generates a first light output having a first wavelength and the second lens generates a second light output having a second wavelength different from the first wavelength.

13. The luminaire of any of claims 1-9, wherein the first lens generates a first light output having a narrow width and the second lens generates a second light output having a width wider than the narrow width.

14. The luminaire of any of claims 1-9, further including a single piece extrusion for supporting the lenses.

15. The luminaire of any of the foregoing claims, further including a power source for powering the first or second light sources, the power source being mounted in contact with the single piece extrusion.

16. The luminaire of any of claims 1-3, wherein the fixture further comprises a first compartment including the first light source and a second compartment including the second light source, and wherein the first lens covers the first chamber and the second lens covers the second compartment.

17. The luminaire of claim 16, wherein the first light source includes a plurality of lights, and wherein the second light source includes a plurality of lights.

18. The luminaire of claim 16, wherein the first compartment and the second compartment are spaced from each other in the longitudinal direction.

19. The luminaire of claim 16, wherein the first compartment and the second compartment are spaced from each other in a lateral direction.

20. An apparatus for lighting a space, comprising:
a first luminaire including a first fixture and a first light source associated with a first lens;
a second luminaire including a second fixture and a second light source associated with a second lens;
wherein the first and second lenses produce different outputs and are interchangeable between the first and second luminaires.

21. The apparatus of claim 20, wherein the first luminaire includes a third lens interchangeable with the first lens or the second lens.

22. The apparatus of claim 20, wherein the first and second lenses are elongated in a longitudinal direction.

23. A luminaire including a fixture supporting at least one slidably removable lens for regulating light emanating from a plurality of light sources.

24. A luminaire including a fixture supporting at least four slidably removable lenses for regulating light emanating from a plurality of light sources.

25. The luminaire according to any of the foregoing claims, wherein the or each fixture comprises a single piece extrusion in contact with a power source for powering at least one light source.

26. The luminaire of claim 25, wherein the fixture is in contact with a plurality of power sources for powering one or more light sources.

27. A method of providing service for the luminaire purchased by a purchaser of any of the foregoing claims, comprising:
providing to the purchaser one or more first replacement lenses for one or more original lenses of the luminaire based on a pre-determined event.

28. The method of claim 27, wherein the predetermined event is selected from the group consisting of the passage of a specific amount of time, a determination that the existing light output lens is at or below a specified original or estimated original light output, or a combination thereof.

29. The method of claim 27, wherein the predetermined event is selected based on one or more of a type of facility in which the luminaire is located and the type of industry occurring at a facility in which the luminaire is located.

30. The method of claim 27-29, further including the steps of:
removing the lens and replacing it with the first replacement lens; and
providing one or more second replacement lenses for the one or more first replacement lenses of the luminaire based on a pre-determined event.

31. The method of claim 27, further including the steps of replacing a first lens of the luminaire with a first replacement lens, and replacing the second lens of the luminaire with a second replacement lens, wherein the first replacement lens and the second replacement lens produce different light outputs.

32. A method of providing different light outputs from a single luminaire having a plurality of light sources, comprising:
providing a first lens in the single luminaire for producing a first light output from one of the light sources;
providing a second lens in the single luminaire for producing a second light output from another of the light sources; and
exchanging the first lens with either the second lens or a third lens different from the second lens, said third lens having a third light output different from the first or second light output.

33. A method of providing service for a luminaire, comprising:
providing service for a luminaire based on the occurrence of a pre-determined event.

34. The method of claim 33, wherein the predetermined event is selected from the group consisting of the passage of a specific amount of time, a determination that the existing light output lens is at or below a specified percentage of an original or estimated original light output, or a combination thereof.

35. The method of claim 33, wherein the predetermined event is selected based on one or more of a type of facility in which the luminaire is located and the type of industry occurring at a facility in which the luminaire is located.

36. The method of claim 33, further including the step of:
removing the original lens and replacing it with the first replacement lens; and
providing one or more second replacement lenses for the one or more first replacement lenses of the luminaire based on a pre-determined event.

37. The method of claim 33, further including the step of replacing a first lens of the luminaire with a first replacement lens, and replacing the second lens of the luminaire with a second replacement lens, wherein the first replacement lens and the second replacement lens produce different light outputs.

38. The method of claim 33, wherein the providing step is performed by a seller of the luminaire in connection with an original sale of the luminaire by a purchaser.

39. The method of claim 38, wherein the providing step is provided by other than a seller of the luminaire to a purchaser.

40. A method of regulating a light output from a luminaire including at least one removable lens, comprising:
after a period of time following an installation of the luminaire, checking the light output;
replacing the at least one lens if the light output is below a predetermined level.

41. The method of claim 40, wherein the replacing step is performed based on a service contract between a seller of the luminaire and a purchaser of the luminaire.

42. A method of regulating a light output from a luminaire including at least one removable lens purchased by a purchaser directly or indirectly from a seller, comprising:
after a period of time following an installation of the luminaire by or for the purchaser, the seller replacing the at least one lens with a replacement lens.

43. The method of claim 42, wherein the replacing step is performed based on a service contract between the seller of the luminaire and the purchaser of the luminaire.

44. The method of claim 41 or 43, further including the step of providing the service contract specifying a time interval for replacing the at least one lens with a replacement based on an amount of light output during or at the end of the time interval.

45. The method of claim 44, further including the step of specifying the time interval and the amount of light output based on a characteristic of the purchaser.

46. A method of selling a luminaire, comprising:
at a point of sale, providing a service obligation respecting maintenance of the luminaire.

47. The method of claim 46, further including the step of providing for service of a luminaire based on an amount of light output.

48. The method of claim 46, further including the step of providing for service of a luminaire based on an amount of light output after a particular amount of time passes.

49. The method of claim 46, further including the step of providing for service of a luminaire based on an amount of light output after a particular amount of time and for a particular commercial or industrial use of the luminaire.

50. A method of selling a luminaire, comprising:
providing a service obligation respecting replacing one or more lenses of the luminaire.

51. The method of claim 50, further including the step of providing the service obligation based on a light output by the luminaire.

52. The method of claim 51, further including the step of delivering the one or more lenses to a location of the luminaire.
